(19) United States
(12) Patent Application Publication
(10) Pub. No.: US 2003/0060242 A1
(43) Pub. Date: Mar. 27, 2003

(54) Microphone switchover circuit

(76) Inventor: Kevin Dotzler, San Diego, CA (US)

Correspondence Address: HARNESS, DICKEY & PIERCE, P.L.C., P.O. BOX 828, BLOOMFIELD HILLS, MI, 48303, US

(21) Appl. No.: 09/966,244

(22) Filed: Sep. 27, 2001

(51) Int. Cl. H04M 1/00

(52) U.S. Cl. 455/569; 455/550

(57) ABSTRACT

A telephone switching circuit includes a single bias circuit for a plurality of microphones. A single pole, single throw (SPST) switch selectively connects one of the microphones to the bias circuit. When a headset microphone is not connected to the circuit, the switch connects the handset microphone to the bias circuit. When the headset microphone is connected, the switching circuit detects the bias current flowing to the headset microphone and opens the SPST switch to disconnect the handset microphone from the bias circuit.

### TECHNICAL FIELD

This invention relates to microphones for mobile telephones, and more particularly to a switch for controlling the biased microphone.

### BACKGROUND

In recent years, the use of hand-held, portable radiotelephones has increased dramatically. Accompanying an increase in use of such portable radiotelephones has been a desire for easy and convenient operation of these devices. In particular, manufacturers of mobile cellular radiotelephones have long sought to provide efficient hands-free operation. In automobiles, for example, it is desirable to provide hands-free telephones for driver safety and convenience. With hands-free operation, the driver of a vehicle may use both hands to control the automobile.

Conventional cellular telephones, which have become extremely popular, are cumbersome to use, especially by the driver of a vehicle. If the telephone is picked up and held by hand, the driver loses the use of that hand for driving or other purposes. In an effort to free up both hands, drivers often attempt to hold the phone between the shoulder and neck, which is not only uncomfortable but also dangerous because it restricts the full range of head movement and peripheral vision necessary for safe driving.

To solve these problems, many manufacturers have developed headsets for use with mobile telephones. The headsets include an earpiece to allow a user to hear the incoming conversation and a microphone for the user to use to transmit the user's voice to the telephone. With the addition of the second microphone, the telephones need a method to determine which microphone is active and select the appropriate microphone.

### SUMMARY

A telephone switching circuit includes a single bias circuit for a plurality of microphones. A single pole, single throw (SPST) switch selectively connects one of the microphones to the bias circuit. When a headset microphone is not connected to the circuit, the switch connects the handset microphone to the bias circuit. When the headset microphone is connected, the switching circuit detects the bias current flowing to the headset microphone and opens the SPST switch to disconnect the handset microphone from the bias circuit.

### DESCRIPTION OF DRAWINGS

These and other features and advantages of the invention will become more apparent upon reading the following detailed description and upon reference to the accompanying drawings.

FIG. 1 illustrates components of a wireless communication system appropriate for use with an embodiment of the invention.

FIG. 2 illustrates a telephone set including a headset for use with an embodiment of the invention.

FIG. 3 is a circuit diagram of a microphone switching circuit using a single pole, double throw switch according to the prior art.

FIG. 4 is a circuit diagram of a microphone switching circuit using a single pole, single throw switch according to an embodiment of the invention.

### DETAILED DESCRIPTION

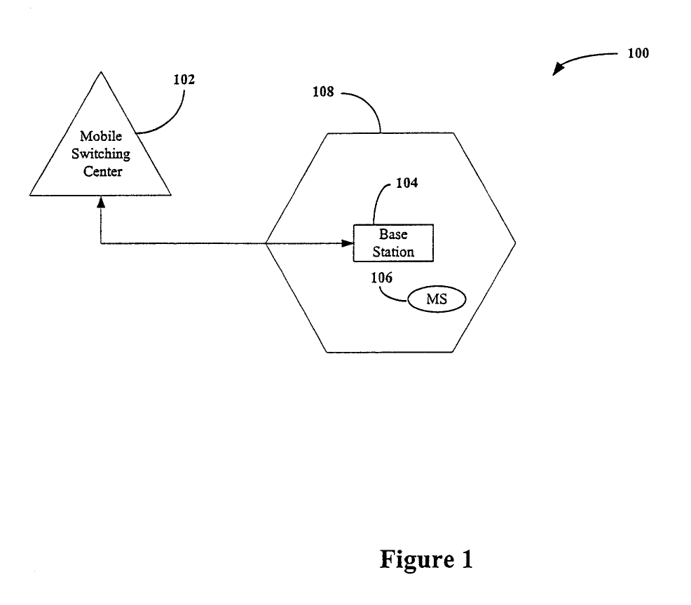

FIG. 1 illustrates components of a wireless communication system. A mobile switching center 102 communicates with a base station 104. The base station 104 broadcasts data to and receives data from mobile stations 106 within a cell 108. The cell 108 is a geographic region, roughly hexagonal, having a radius of up to 35 kilometers or possibly more.

The mobile station 106 is capable of receiving data from and transmitting data to a base station 104. Additional cells adjacent to the cell 108 permit mobile stations 106 to cross cell boundaries without interrupting communications. This is because base stations 104 in adjacent cells assume the task of transmitting and receiving data for the mobile stations 106. The mobile switching center 102 coordinates all communication to and from mobile stations 106 in a multi-cell region, thus the mobile switching center 102 may communicate with many base stations 104.

The mobile stations 106 may move about freely within the cell 108 while communicating either voice or data. The mobile stations 106 not in active communication with other telephone system users may, nevertheless, scan base station 104 transmissions in the cell 108 to detect any telephone calls or paging messages directed to the mobile station 106.

One example of such a mobile station 106 is a cellular telephone used by a pedestrian who, expecting a telephone call, powers on the cellular telephone while walking in the cell 108. The cellular telephone synchronizes communication with the base station 104. The cellular telephone then registers with the mobile switching center 102 to make itself known as an active user within the wireless network.

The mobile station 106 scans data frames broadcast by the base station 104 to detect any telephone calls or paging messages directed to the cellular telephone. In this call detection mode, the mobile station 106 receives, stores and examines paging message data, and determines whether the data contains an identifier matching an identifier of the mobile station 106. If a match is detected, the mobile station 106 establishes a call with the mobile switching center 102 via the base station 104. If no match is detected, the mobile station 106 enters an idle state for a predetermined period of time, then exits the idle state to receive another transmission of paging message data.

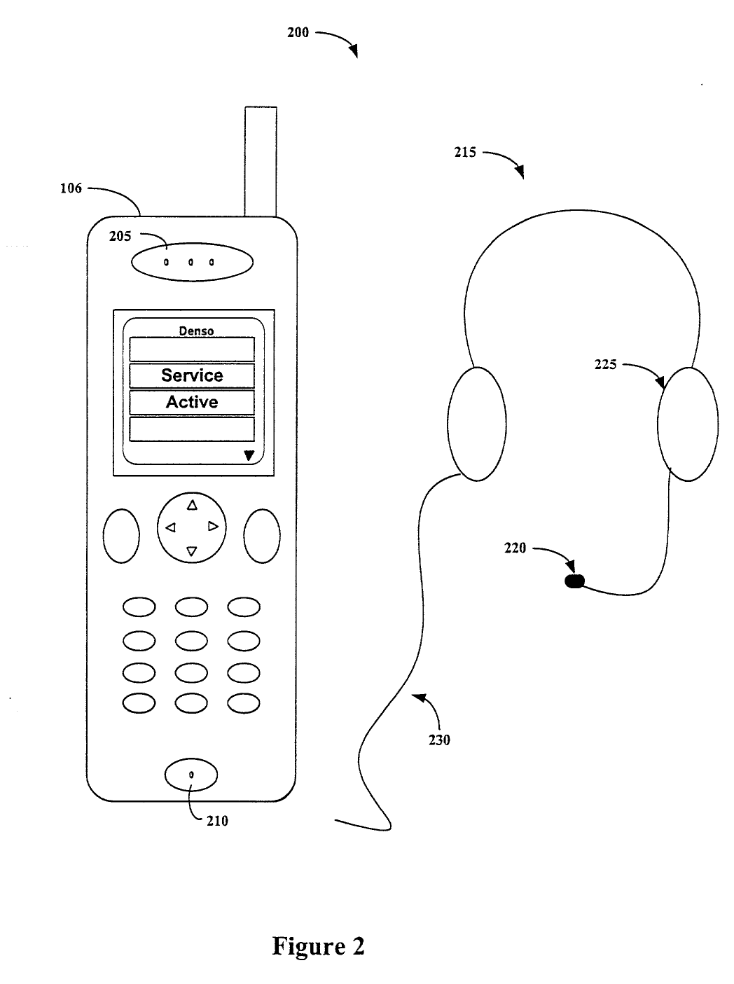

FIG. 2 illustrates a telephone set 200 according to one embodiment of the invention. The telephone set 200 includes the mobile station 106 and a headset 215. The mobile station 106 includes a speaker 205 and a microphone 210. During normal phone conversations, a user may place the speaker 205 against his ear and speak into the microphone 210. During this normal usage, the mobile station 106 directs the sound to the speaker 205 and receives input from the microphone 210.

The headset 215 includes a microphone 220, earpieces 225, and a connector cord 230. When the connector cord is attached to the mobile station 106, the speaker 205 and microphone 210 on the mobile station 106 are deactivated and the earpieces 225 and microphone 220 of the headset are activated. This allows a user to wear the headset 215 and use the telephone set 200 in a hands-free mode.

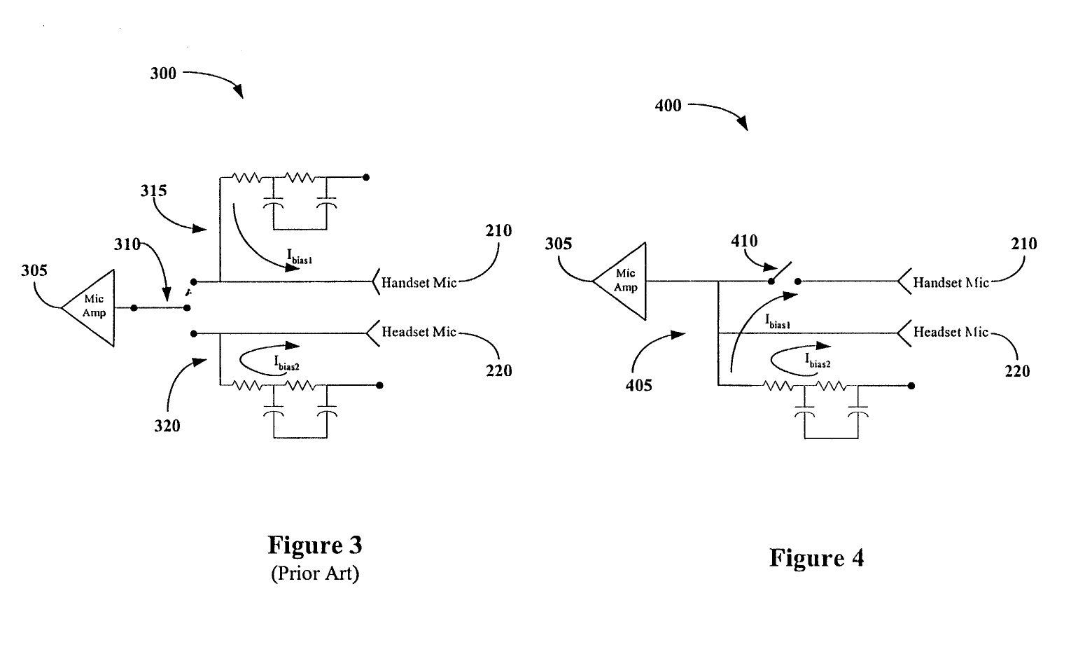

FIG. 3 is a diagram of a microphone switching circuit 300 according to the prior art. The switching circuit 300 includes a microphone amplifier 305, a single pole, double throw (SPDT) switch 310, the handset microphone 210 with a handset bias loop 315, and the headset microphone 220 with a headset bias loop 320. The SPDT switch 310 selectively connects either the handset bias loop 315 or the headset bias loop 320 to the microphone amplifier 305. If the user is speaking directly into the mobile station 106, the SPDT switch 310 connects to the handset bias loop 315. This allows a first bias current I_{bias1} to flow through the handset bias loop 315. Thus, the handset microphone 210 is connected to the microphone amplifier 305. With the SPDT switch 310 connected to the handset bias loop 315, the headset bias loop 320 is disconnected from the microphone amplifier, thus creating an open circuit and no bias current I_{bias2} flows.

If the headset 215 is connected to the mobile station 106, the user will speak into the headset microphone 220. In this circumstance, the SPDT switch 310 connects to the headset bias loop 320. This allows a second bias current I_{bias2} to flow through the headset bias loop 320. Thus, the headset microphone 220 is connected to the microphone amplifier 305. With the SPDT switch 310 connected to the headset bias loop 325, the handset bias loop 315 is disconnected from the microphone amplifier, thus creating an open circuit and no bias current I_{bias1} flows.

As can be appreciated, the use of a SPDT switch 310 requires the use of a separate bias loop for each of the microphones 210, 220. Each bias loop requires a plurality of components and increases the cost of manufacturing the mobile station 106.

FIG. 4 is a circuit diagram of a microphone switching circuit 400 according to one embodiment of the invention. The switching circuit 400 incorporates a single pole, single throw (SPST) switch 410 and a single microphone bias loop 405. When the handset microphone 210 is in use, the SPST switch is closed, thereby connecting the handset microphone 210 to the microphone amplifier 305. In this configuration, a first bias current I_{bias1} flows through the bias loop 405 to the handset microphone 210. Because the headset microphone 220 is not connected to the mobile station 106, there value of the second bias current I_{bias2} is zero. This is because the headset microphone 220 presents an open circuit to the bias loop 405.

When the connector cord 230 of the headset 215 is inserted into the mobile station 106, the headset microphone 220 is activated. Connecting the headset microphone into the microphone switching circuit 400 causes the second bias current I_{bias2} to flow. The SPST switch 410 is set to detect the second bias current I_{bias2} and open upon detection. This disconnects the handset microphone 210 from the bias loop 405, leaving only the headset microphone 220 connected. Because the SPST switch is open, the first bias current I_{bias1} does not flow. Thus, using a single bias loop, the switching circuit 400 is able to selectively connect either the headset microphone 220 or the handset microphone 210. Further, power consumption may be further reduced by opening the SPST switch 410 when neither microphone 210, 220 is in use. This effectively stops all power consumption within the bias loop 405.

The control logic for the SPST switch 410 may be built into the switching circuit 400 or may be a function of software control. The mobile station 106 may include an integrated circuit, or processor, to control other functions. The logic control for the SPST switch 410 may be incorporated into any integrated circuit within the mobile station 106.

Numerous variations and modifications of the invention will become readily apparent to those skilled in the art. Accordingly, the invention may be embodied in other specific forms without departing from its spirit or essential characteristics.

What is claimed is:

1. A method of selecting an active microphone in a telephone circuit comprising:
determining whether a first microphone is connected to the telephone circuit; and
disconnecting a second microphone when the first microphone is connected, wherein the first microphone and the second microphone share a bias circuit.

2. The method of claim 1, further comprising disconnected the second microphone by opening a switch.

3. The method of claim 2, further comprising opening a single pole, single throw switch.

4. The method of claim 1, further comprising detecting a bias current to determine whether the first microphone is connected.

5. The method of claim 1, further comprising the first microphone being a headset microphone.

6. The method of claim 1, further the second microphone being a handset microphone.

7. The method of claim 1, further comprising connecting the second microphone to the telephone circuit when the first microphone is disconnected.

8. The method of claim 7, further comprising determining the first microphone is disconnected by sensing a lack of bias current.

9. A telephone switch circuit comprising:
a bias circuit connected to a microphone amplifier; and
a switch which connects either a first microphone or a second microphone to the bias circuit, wherein the switch connects the first microphone to the circuit when the first microphone is present.

10. The telephone switch circuit of claim 9, wherein the switch is a single pole, single throw switch.

11. The telephone switch circuit of claim 9, wherein the first microphone is a headset microphone.

12. The telephone switch circuit of claim 9, wherein the second microphone is a handset microphone.

13. The telephone switch circuit of claim 9, wherein the switch opens to disconnect the second microphone from the bias circuit when the first microphone is detected.

14. The telephone switch circuit of claim 13, wherein the first microphone is detected by sensing a bias current flowing through the bias circuit.
